(19) United States
(12) Patent Application Publication
(10) Pub. No.: US 2013/0301866 A1
(43) Pub. Date: Nov. 14, 2013

(54) Acoustic Device

(71) Applicant: Deben Acoustics Limited, Suffolk (GB)

(72) Inventor: Graham BANK, Suffolk (GB)

(21) Appl. No.: 13/892,387

(22) Filed: May 13, 2013

(30) Foreign Application Priority Data
May 11, 2012 (GB) 1208247.5

(51) Int. Cl. H04R 9/04; H04R 31/00

(52) U.S. Cl. CPC H04R 9/04; H04R 31/003
USPC 381/401; 381/400; 29/594

(57) ABSTRACT

The invention relates to an acoustic device and a method of making the same. The acoustic device comprises a diaphragm having an area and having an operating frequency range comprising a part in which the diaphragm moves in whole body mode and a part which includes at least the first bending mode. The acoustic device also comprises a moving coil transducer adapted to move the diaphragm in translation and having a voice coil coupled to the diaphragm and a magnet system and adapted to exchange energy with the diaphragm. The acoustic device also comprises at least one mechanical impedance means coupled to or integral with the diaphragm. The positioning and mass of the transducer voice coil and of the at least one mechanical impedance means is such that the net modal transverse velocity over the area of the diaphragm tends to zero. The transducer comprises a moving coil assembly having a coil former on which are mounted a plurality of voice coils in an axially-spaced array.

### TECHNICAL FIELD

The invention relates to acoustic devices, such as loudspeakers and microphones, more particularly bending wave devices.

### BACKGROUND ART

Many types of acoustic device are known and one common form comprises a magnet and moving coil arrangement attached to a diaphragm. The diaphragm may be driven as a piston whereby the whole body of the diaphragm is being displaced, in bending wave vibration whereby bending waves are travelling within the diaphragm or in a combination of the two modes of operation. A cone diaphragm is relatively rigid for its mass and thus tends to operate over most of its frequency range as a piston before breaking into secondary resonances. By contrast, a panel diaphragm will operate in bending at a relatively low frequency. Bending wave loudspeakers will have resonant bending wave modes which are standing waves within the diaphragm and which occur when there is reflection of waves at boundaries of the diaphragm. Resonant bending wave modes occur at particular discrete frequencies given, roughly, by the frequencies at which a number (n+½) wavelengths fit inside the diaphragm, where n is a natural number (0,1,2,3 . . . ).

A microphone which uses a moving coil arrangement is shown in UK Patent GB705100A. FIG. 1 is an extract from GB705100A and shows a device comprising a hollow magnet structure with two ferro-magnetic plates P1, P2 and co-axial similar apertures A1 and A2. Two flexible members D1 and D2 are supported parallel to the outer faces of the plates P1 and P2. D1 is a suspension member and D2 is a sound producing diaphragm with a central dome CD. Speech coils C1 and C2 are wound on a former F so as to be situated in the gaps between plate P1 and pole piece PP1 and plate P2 and pole piece PP2, respectively.

Bending wave loudspeakers are described, for example, in WO97/09842 and WO2005/101899. As set out in the introduction to WO2005/101899, a pure force applied to theoretical, free mounted bending wave panel speaker will result in an output with both flat pressure and flat power responses with frequency. However, all practical means of delivering a driving force have compliances and masses associated with this driving force which unbalance the panel's modal behaviour. This results in an uneven response both in the pressure and power outputs. WO2005/101899 describes a solution to this problem in which at least one mechanical impedance means is used to balance the panel modal behaviour such that the net transverse modal velocity over the panel area tends to zero.

WO2005/101899 also explains that if the net transverse modal velocity is zero, the relative mean displacement will also be zero. The relative mean displacement is calculable and an example of the equation for a circular diaphragm is given. To achieve net transverse modal velocity tending to zero, the relative mean displacement may be less than 0.25 or less than 0.18, (i.e. less than 25% or less than 18% of the rms transverse velocity).

Furthermore, as described in WO2005/101899, for zero net transverse modal velocity, the modes of the diaphragm need to be inertially balanced to the extent, that except for “whole body displacement” or “piston” mode, the modes have zero mean displacement (i.e. the area enclosed by the mode shape above the generator plane equals that below the plane). This means that the net acceleration, and hence the on-axis pressure response, is determined solely by the pistonic component of motion at any frequency. This is the condition which gives an even pressure and power response.

FIG. 2 is extracted from WO2005/101899 and shows a loudspeaker comprising a diaphragm in the form of a circular panel 10 and a transducer 12 having a voice coil 26 concentrically mounted to the panel. Three annular masses 20,22,24 are concentrically mounted to the panel 10. The panel and transducer are supported in a circular chassis 14 which comprises a flange 16 to which the panel 10 is attached by a circular suspension 18. The locations of the voice coil 26, each mass and the suspension are average nodal positions of the modes of the panel which appear in the operating frequency range. As explained in WO2005/101899, such average nodal positions tend to be near the nodes of the highest mode considered, but the influence of the other modes means that the correspondence may not always be exact.

In order to generate low frequencies in any loudspeaker the displacement of the diaphragm needs to increase as the inverse square of the frequency. By way of example, generating the same pressure at 50 Hz to that of 100 Hz would require a 2²=4 increase in diaphragm excursion. For a device like that described in WO 2005/101899, this would require a device with a much larger excursion capability. The ratio of the length of the voice coil to the thickness of the front plate determines the excursion capability. Accordingly, low frequencies can only be reproduced with acceptable levels of distortion by longer voice coils. In lengthening the voice coil it would be expected that the mass of the voice coil would also increase. For a device made in accordance with the teaching of WO 2005/101899, this would mean a corresponding increase in the balancing masses. This would lead to a significant loss of sensitivity because the whole moving mass would have increased significantly.

Accordingly the present applicant has recognised that an alternative arrangement for achieving low frequencies is required.

Statements of Invention

According to a first aspect of the invention, there is provided an acoustic device comprising
a diaphragm having an area and having an operating frequency range comprising a part in which the diaphragm moves in whole body mode and a part which includes at least the first bending mode,
a moving coil transducer adapted to move the diaphragm in translation and having a voice coil coupled to the diaphragm and a magnet system and adapted to exchange energy with the diaphragm, and
at least one mechanical impedance means coupled to or integral with the diaphragm,
the positioning and mass of the transducer voice coil and of the at least one mechanical impedance means being such that the net modal transverse velocity over the area of the diaphragm tends to zero,
wherein the transducer comprises a moving coil assembly having a coil former on which are mounted a plurality of voice coils in an axially spaced array.

According to a second aspect of the invention, there is provided a method of making an acoustic device comprising a diaphragm having an area and having an operating frequency range with a part in which the diaphragm moves in whole body mode and a part which includes at least the first bending mode,

the method comprising

choosing the diaphragm parameters such that it has at least one resonant mode in the operating frequency range,

coupling the voice coil of a moving coil transducer to the diaphragm to exchange energy with the diaphragm,

arranging at least one mechanical impedance means coupled on the diaphragm, and arranging the positioning and mass of the transducer voice coil and of the at least one mechanical impedance means to be such that the net modal transverse velocity over the area of the diaphragm is at least reduced to tend to balance at least selected modes in the operating frequency range with the balancing of the selected modes being achieved substantially by the positioning and mechanical impedance of the transducer, and

arranging the moving coil to comprise an assembly having a coil former on which are mounted a plurality of voice coils in an axially spaced array.

The following features apply to both aspects of the invention.

The traditional magnetic circuit used for devices shown in WO 2005/101899 has a single air gap with the flux travelling through this air gap being generated by at least one permanent magnet. There may be additional magnets to reduce the flux leakage and steel plates to direct the flux. The disadvantage of this device for low frequencies is the inherent asymmetry of the flux pattern which leads to distortion and the need to lengthen the coil and thereby adding mass if lower frequencies need to be reproduced.

In the present invention, the magnetic circuit has a coil which is split into two or more coils. Accordingly, there are at least two magnetic flux gaps and thus it is possible to increase the linear excursion of the driving force without increasing the overall mass of the coil. Accordingly, no additional mechanical impedances are required.

Split (or dual) coils are not new. Button in U.S. Pat. No. 5,748,760 describes a device using dual coils to increase the power handling of a traditional loudspeaker. Xin Xu and Ying-Jun Guo, J. Audio Eng. Soc. Vol. 57, No. 11. November 2009, describe a dual coil dual magnet variation to improve the linearity of a loudspeaker. In both these cases either the linearity or power handling is the target parameter of interest. By contrast, the present invention is attempting to counteract the mechanical impedance delivered by the driving force, which for the most part can be considered, for a moving coil transducer, to be dominated by the mass of the voice coil.

The plurality of voice coils may be electrically connected one to the other, e.g. in series or in parallel or may be electrically separate and driven from separate amplifiers. Of course, in the case of electrically separate voice coils, the driving amplifiers must be fed with the same signal so that the voice coils work in cooperation.

The diaphragm may be a generally circular, rectangular or square diaphragm. Alternatively, other shapes may be used. The diaphragm is preferably in the form of a panel which may be substantially flat or may be curved.

The diaphragm may be driven by a plurality of moving coil transducers. The or each transducer may have symmetrical magnetic circuits for the plurality of voice coils. The voice coils may be symmetrically positioned on the voice coil former. Such a symmetrical arrangement of the two magnetic circuits and the symmetrical positioning of the coils may lead to improved linearity of the device.

The device may further comprise a coupling device connected between the, or each, coil former and the diaphragm. The coupling device may be connected to the diaphragm at or adjacent to the first nodal line of bending resonance of the diaphragm. The coupling device may be in the form of a truncated cone. The coupling device may be as taught in WO2009/153591.

The device may comprise an amplifier. For an amplifier requiring an 8 ohm load, the device may have two 16 ohm split coils which may be connected in parallel. The amplifier may have two channels and a first device as described above may be connected to one of the channels and a second device connected to the other channel to make a stereo set-up. Alternatively, a single device may be used (e.g. as a portable single speaker). In this case, both channels may be connected to the device. For an amplifier requiring an 8 ohm load, the device may have two 8 ohm coils each having lead outs bringing the coil ends out separately whereby each of the coils could be connected to each amplifier channel. They would both be driven with the same signal, so would cooperate in moving the coil assembly, but using both channels matched to an 8 ohm load would give more output.

This invention combines the improved linearity generated by a split coil which has been designed to be the same mass as that of a coil which has been balanced in a balanced mode radiator device built in accordance with WO 2005/101899. This will give the extra excursion needed for low frequency and improved linearity without the penalty of additional mass in the voice-coil.

### BRIEF DESCRIPTION OF DRAWINGS

FIG. 1 is a cross section of a prior art device extracted from UK Patent GB705100A;

FIG. 2 is a cross section of a prior art device extracted from WO 2005/101899;

FIG. 3 is a cross section of a first embodiment of the present invention;

FIG. 4 is a cross section of a further embodiment of the device;

FIG. 5 is a cross section of an alternative embodiment using an outer magnet;

FIG. 6 is a perspective view of the coil assembly showing the embodiment;

FIG. 7 is a close-up of the coil assembly of FIG. 6;

FIG. 8 is a graph showing the variation in BL product against relative coil assembly position when the coil assembly is moved through the magnetic air gap, for different spacing distances between the upper and lower coils on the former;

FIG. 9 is a graph showing the variation in BL product against relative coil assembly position when the coil assembly is moved through the magnetic air gap comparing a device according to the present invention compared with one made in accordance with the prior art;

FIGS. 10a to 10c are plan and side and front cross section views of an alternative embodiment;

FIG. 11 shows an isometric view of the embodiment of FIG. 10a;

FIG. 12 shows an isometric view of the embodiment of FIG. 10a with a coupler;

FIG. 13 shows a cross section of a further embodiment, incorporating a coupler;

FIG. 14 shows a cross section of a further embodiment with a long former;

FIG. 15 shows a cross section of a further embodiment, using a non-flat diaphragm;

FIG. 16 shows a schematic connection of a device to a single amplifier; and

FIG. 17 shows a schematic connection of a device to a pair of amplifiers.

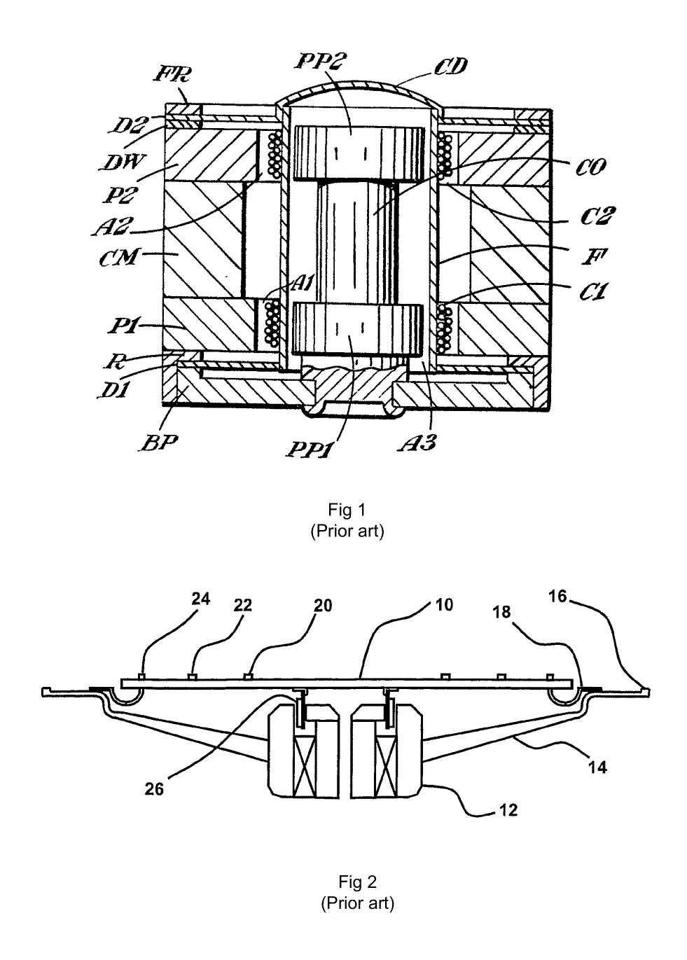

### DETAILED DESCRIPTION OF DRAWINGS

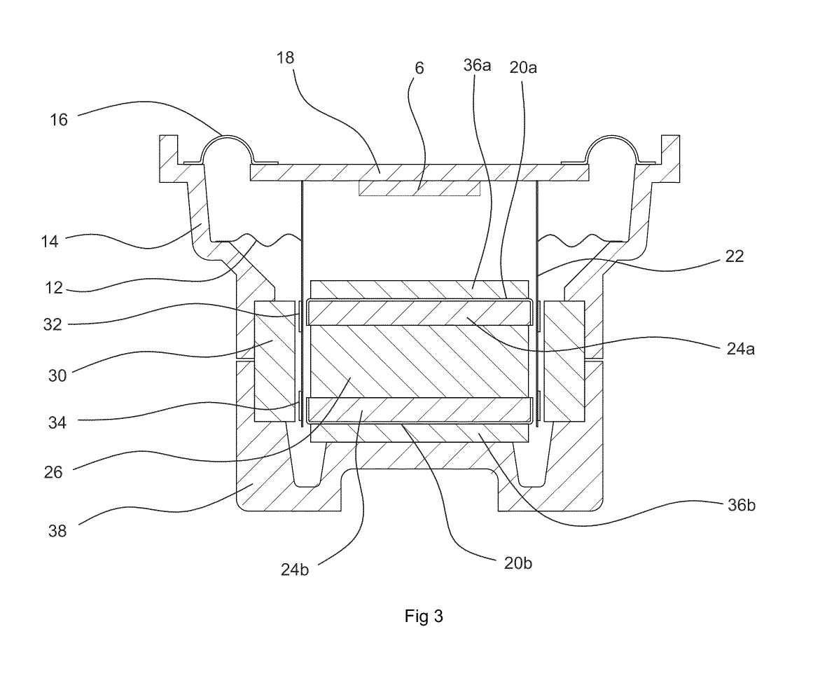

FIG. 3 shows an acoustic device comprising a diaphragm in the form of a circular panel 18 and a transducer concentrically mounted to the panel. The panel and transducer are supported in a circular chassis 14 to which the panel 10 is attached by a circular suspension 16. The transducer comprises a moving coil assembly having a coil former 22 on which are mounted split voice coils 32 and 34. The two coils can be connected in series or parallel. A parallel connection is preferred because this will mean that each coil 32, 34 will have twice the resistance of a single coil counterpart. This is preferred because each coil will have a smaller diameter and therefore be lower in mass than half its equivalent single coil counterpart. This allows the number of turns and overall wind-width to be increased, further improving the linear excursion of the device.

The transducer also comprises a magnet assembly comprising a rear cup 38 which supports a hollow cylindrical steel sleeve 30 within which is housed a permanent generally cylindrical magnet 26 having a pair of circular plates 24a, 24b, one at each opposed end. A pair of air-gaps is defined, one between each plate of the permanent magnet 26 and the cylindrical steel sleeve 30 within which one of the pair of coils each are positioned. A copper cap 20a, 20b may be fitted over each plate to improve the high frequency performance of the device. Furthermore, an optional bucking magnet 36a, 36b may be fitted to each copper cap (or plate where there is no copper cap) to reduce stray magnetic field. Such bucking magnets are commonplace in high quality devices. The rear cup 38 is non-magnetic and can be made from plastic, aluminium, brass, or any other suitable non-magnetic material. This cup 38 houses the outer sleeve 30 which fits snugly into the chassis 14 to ensure that the transducer is concentrically mounted to the diaphragm.

The main magnet 26 provides the magnetic force to drive the two air gaps, which house the coils 32 and 34. The field is generated between the front plates 24a and 24b, and the outer steel sleeve 30. The magnetic fields in the two air gaps are in opposite sense, so the windings of coils 32 and 34 are wired such that the two coils cooperate to provide addition of the two forces. The magnet assembly provides the magnetic flux, B (T), which in combination with the length of wire, L (m), wound onto the former 22 provides a BL (Tm) product. When a current i (amps) flows in this coil the resultant force is BLi (N). The force is transmitted to the panel 18 by way of the former 22 which is constrained to travel in an axial fashion by a suspension 12 attached to the chassis 14. Such a suspension 12 is also known as a flexible spider. The coils 32, 34 on the former 22 are generally identical in wire diameter and number of turns. However, the wire diameter and/or number of turns could be adjusted if the air-gaps were not identical.

The locations of the voice coil former 22 and the suspension 16 are at average nodal positions of the modes of the panel which appear in the operating frequency range in line with the teaching in WO 2005/101899. Furthermore, the acoustic device comprises a mechanical impedance means in the form of a mass 6 which is concentrically mounted to the diaphragm. In line with the teaching of WO 2005/101899, the mass 6 is a single continuous circular mass, which does not stiffen the panel and which replaces a pair of annular discrete masses which could have been mounted at average nodal positions of the modes of the panel. The positioning and mass of the transducer voice coil and of the at least one mechanical impedance means are such that the net modal transverse velocity over the area of the diaphragm tends to zero.

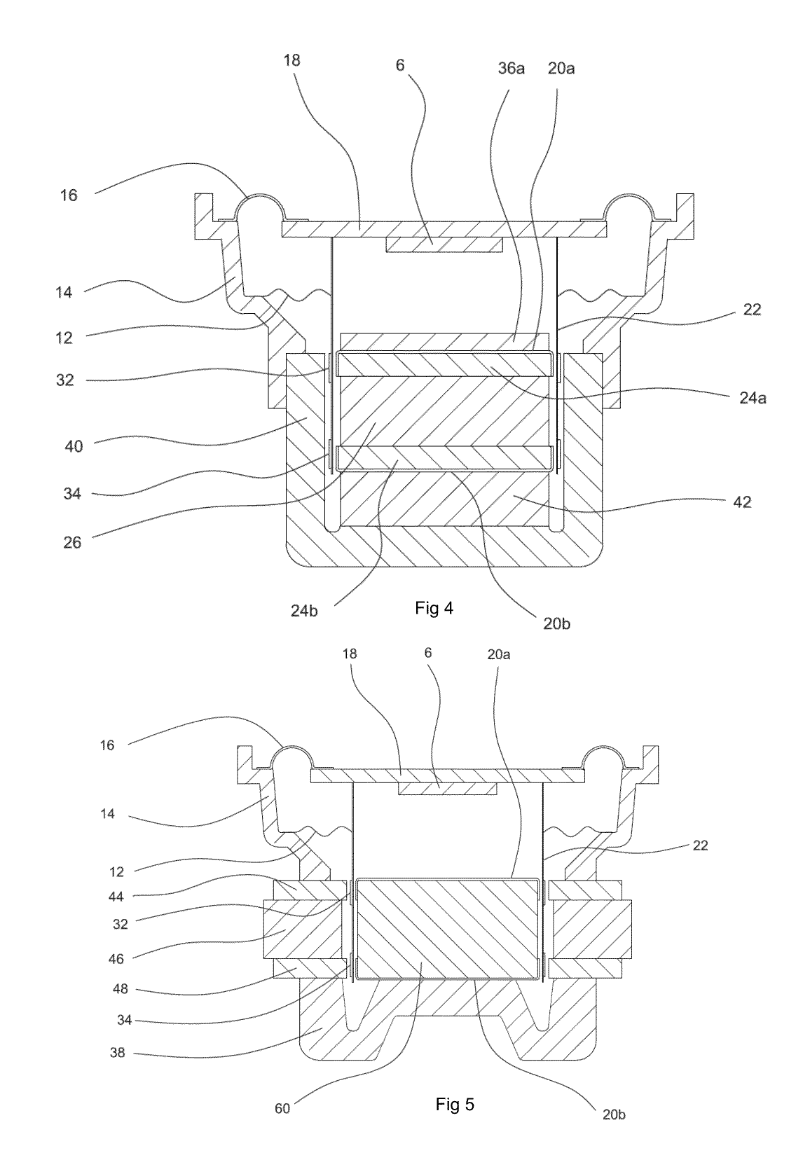

FIG. 4 shows a variation of the transducer of FIG. 3. The rear cap and sleeve are replaced with a steel outer cup 40. One of the bucking magnets 36b is also replaced with a second magnet 42 which is coupled between the steel outer cup and the lower copper cap 20b. This produces a magnetic arrangement which is less symmetric than that shown in FIG. 3, but may have application where a higher sensitivity is required.

FIG. 5 shows an alternative design in which the permanent magnet is fitted on the outside of the coil. This may be for use of different magnet materials, or mechanical considerations. In this case the magnetic circuit is formed by an annular magnet 46 having an annular front plate 44 and an annular rear plate 48 bonded thereto. The annular rear plate 48 is bonded to a rear cap which also supports a central pole 60. Copper caps 20a and 20b can be fitted to the central pole 60 to improve the high frequency performance.

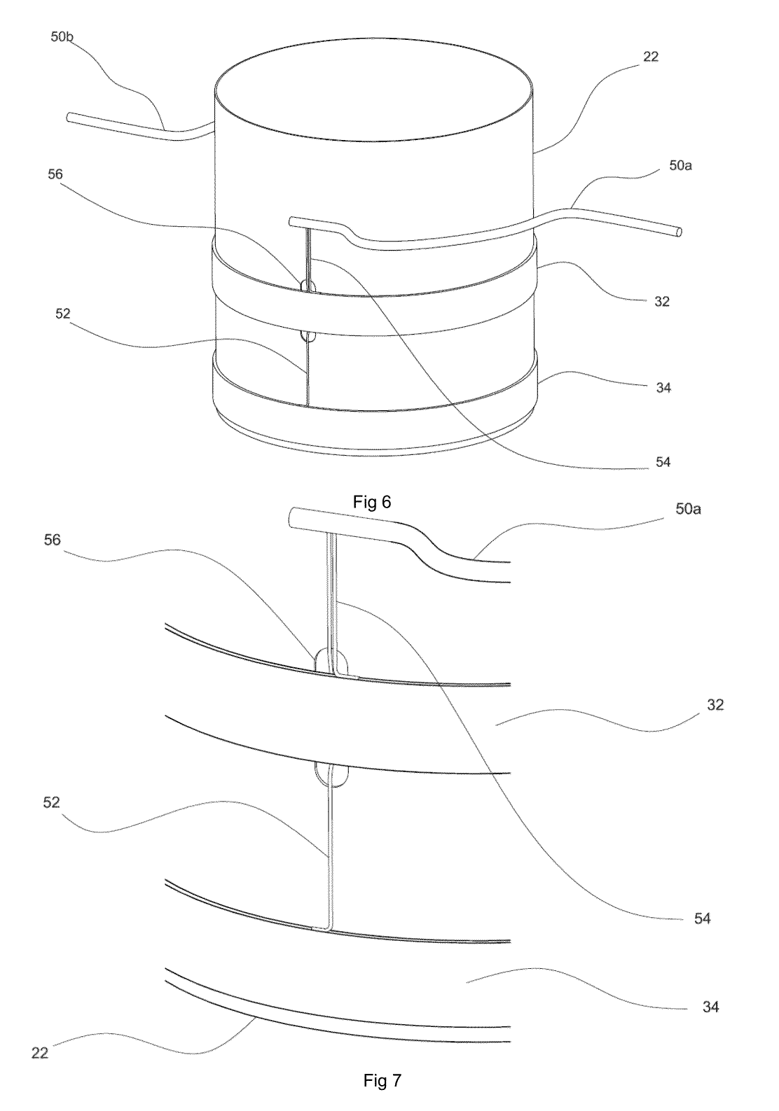

As described with reference to FIG. 3, a parallel connection is preferred and one possible arrangement for such a parallel connection is shown in FIGS. 6 and 7. Anyone skilled in the art of coil winding may use alternative, established methods to connect the coils, provided that they ensure the currents in the two coils flow in opposite directions.

As shown in FIG. 6, the former comprises a pierced aperture 56 behind one of the coils (in this case the upper coil 36). A lead out wire 52 from the lower coil 34 is dressed along the former 22 and through aperture 56 which allows the wire to pass under the upper coil 32. The thickness of the former 22 is such that aperture 56 has sufficient depth to accommodate the wire. This thickness is reduced by choosing the thinner wire which would be needed for two coils in parallel. 50a and 50b are flexible electrical leads by which the voice coils are connected to a drive such as an amplifier. The direction of the current into the two coils needs to be reversed for the lower coil versus the upper coil, and this can be achieved by selecting the wire which leaves the correct layer in each of the two coils. FIG. 7 shows a close-up view to indicate that the lead out wire 52 leaving the lower coil 52 leaves its corresponding windings in the opposite direction to lead out wire 54 which leaves the upper coil.

It is clear that having two coils gives another degree of freedom for the designer. Typically in prior art devices, the designer has little choice but to put the coil windings at, or close to the centre of the magnetic air-gap. This will give the most BL product as well as the best symmetry of BL versus displacement that is possible. In the case of a split coil, as shown in FIG. 3, 4 or 5, the separation of the coils is a variable which can be exploited.

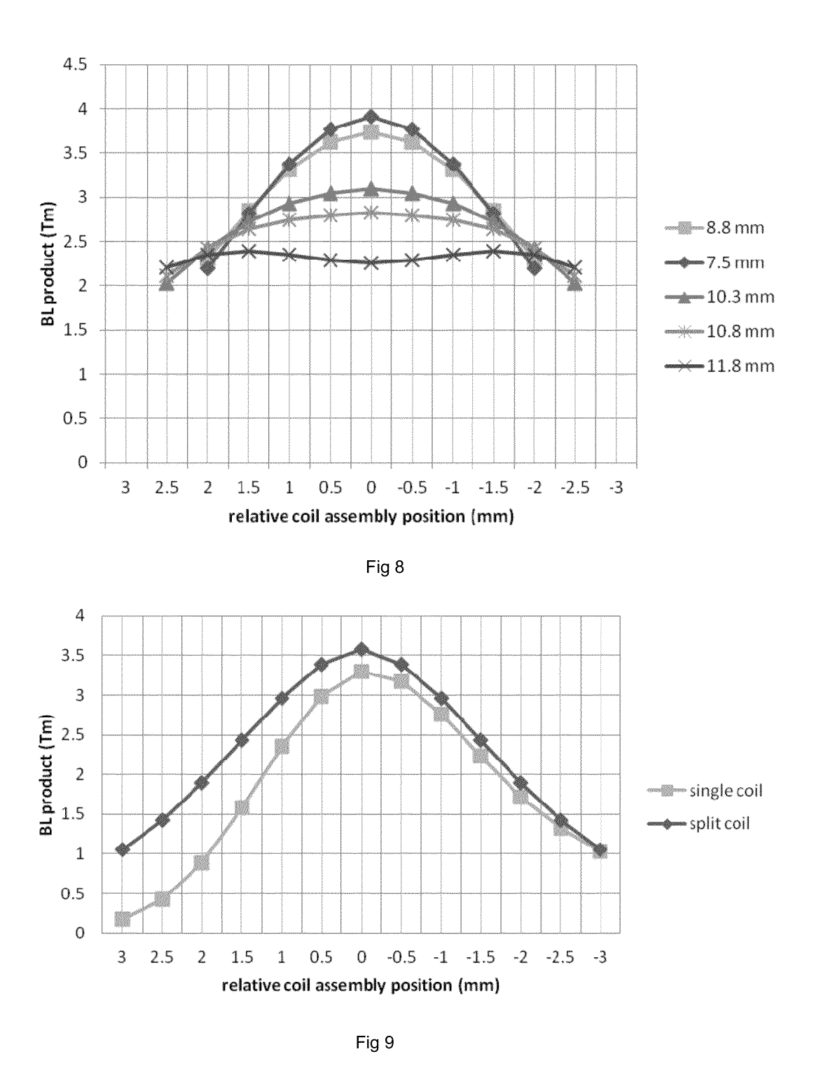

FIG. 8 shows the variation of BL product (Tm) with coil assembly position when the coils have different separations. The front plate and rear plate spacing is kept constant, but the coil spacing is varied. Computer simulation is used to predict the way that the BL product varies as the coil assembly in moved from above (+) to below (−) the nominal resting position. The designer can offset the absolute value of BL product against linearity. For example, a split coil with a gap of 10.8 mm between the pairs of coils has a generally linear region extending approximately 1.5 mm either side of the central position but a maximum of 2.75 Tm. By contrast, a split coil with a gap of 7.5 mm has a maximum BL of nearly 4 Tm but much reduced linearity. The curves are symmetrical and allow a choice of BL product which may be lower, but a much wider region of linearity.

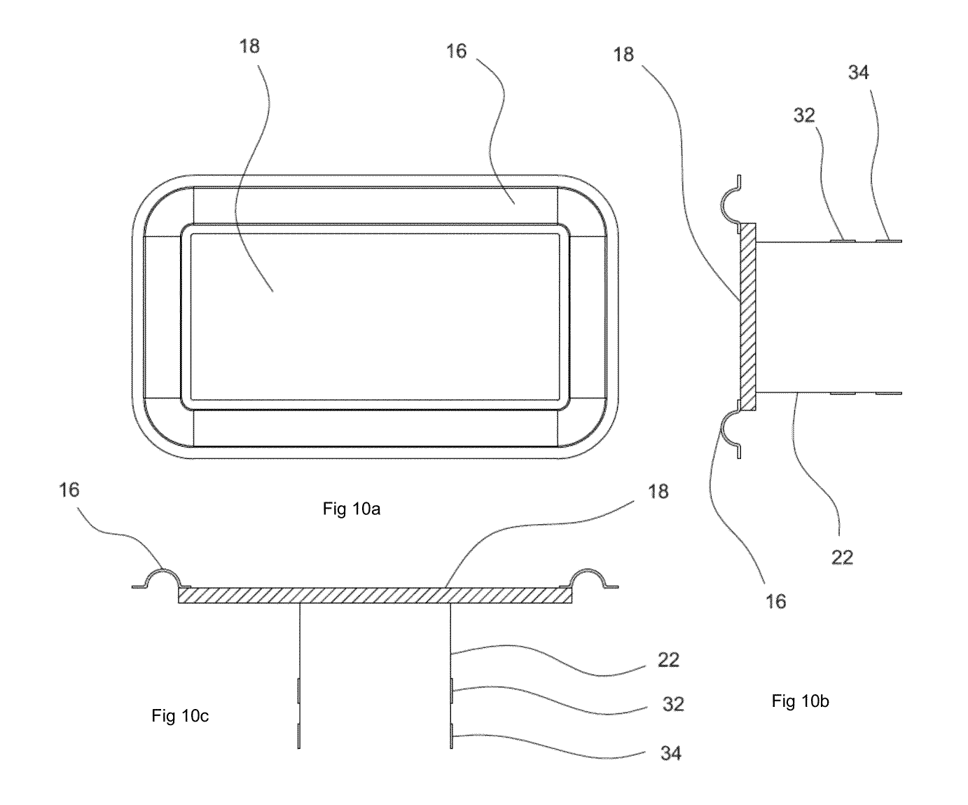

FIG. 9 compares a device based on the teaching in WO 2005/101899 compared with a device as shown in FIG. 3. In each case, the devices are the same except for the use of a split coil versus one with a single coil. Notice the improvement in BL product, but equally important, the gain in symmetry of the BL product, thereby reducing distortion. The use of a split coil may also be used to improve other bending wave acoustic devices where the same requirement for matching balancing masses applies, for example, those described in WO 2009/153591, which use a coupler.

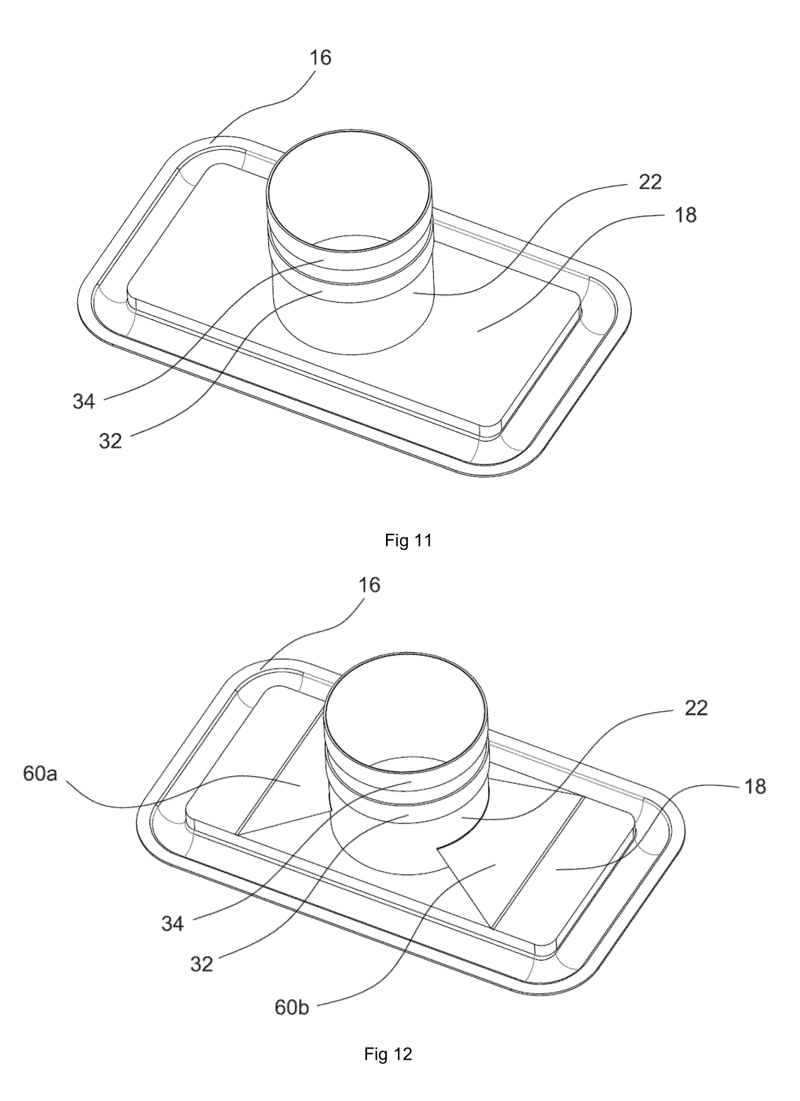

FIGS. 10a to 10c show views of an acoustic device comprising a diaphragm in the form of a rectangular panel 18. It would be possible to construct the panel so that the main dimensions were equal, making the panel square. The panel 18 is suspended on a flexible suspension which is fixed to a surround 16 having a similar shape to the perimeter of the panel. In FIGS. 10b, 10c and 11 the chassis and magnet assembly parts are omitted for clarity. These components would be typically arranged in a similar fashion to those shown in FIG. 3 around the former 22 which has split coils 32 and 34. As shown in FIG. 11, the former 22 is in the form of a cylindrical tube mounted centrally on the rectangular panel.

As described in WO 2009/153591, an auxiliary coupler is connected between the coil former and the diaphragm. The auxiliary coupler has a wider diameter than the coil former where the coupler connects to the diaphragm. By using the coupler, the diaphragm is driven both via the former and via the auxiliary coupler. FIG. 12 shows an embodiment incorporating a coupler 60a, 60b as described in WO 2009/153591. The coupler comprises a pair of truncated triangular panels 60a,60b which are coupled along a curved upper edge to the former 22 and along a longer straight edge to the panel 18. In this way, the panel 18 is driven both by the former 22 and along the lines of connection with the coupler. The two coils 32, 34 are arranged to be spaced from the coupler by a convenient distance.

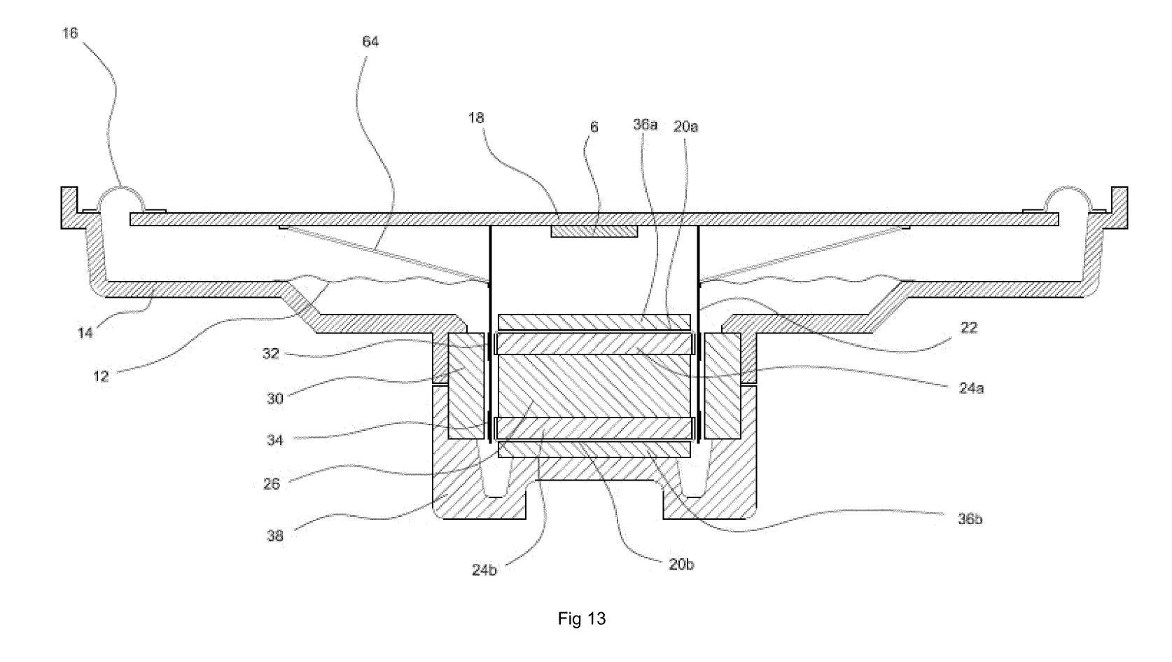

The coupler may be used with any of the embodiments described. For example, the coupler can be used in the embodiment of FIG. 4 as shown in FIG. 13. In this case, the coupler 64 which connects the former 22 to the panel 18 is in the form of a truncated cone. The coupler 64 is connected to the panel 18 at a position as described in WO 2009/153591.

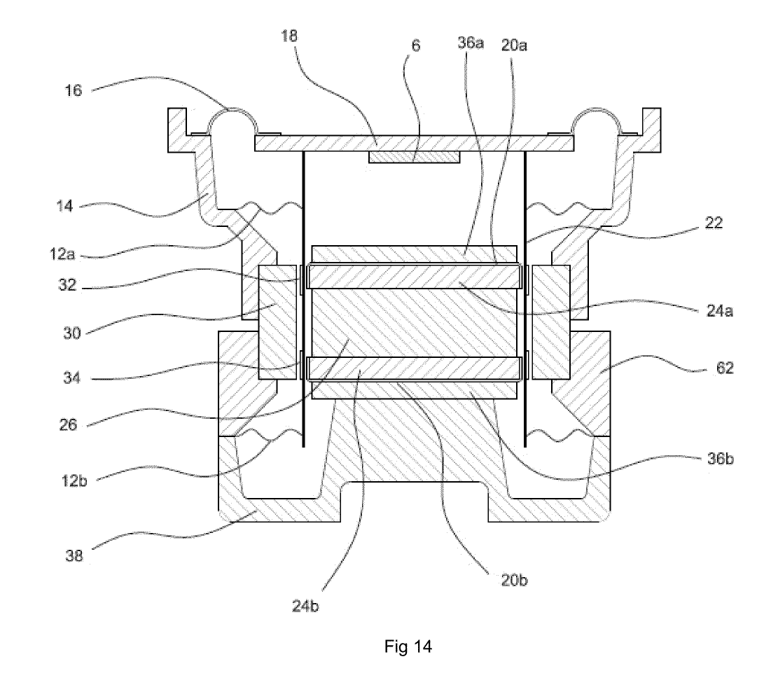

One disadvantage of the use of a split coil design is that the former 22 may be of such a length that it may rock during operation and touch some part of the magnet assembly, causing unwanted buzzing or noise. FIG. 14 shows one method of counteracting this disadvantage on a variation of FIG. 3, although it will be appreciated that it can also be incorporated on the other embodiments. The former 22 is lengthened so that a lower support section extends between and below the magnet assembly. Rear cup 38 is also extended. A second spider 12b is attached to the lower support section and the rear cup 38 complementing the upper spider 12a attached to the upper support section which extends between the top of the magnet assembly and the panel 18. This would prevent any fouling of the coils 32, 34 and/or the former 22 onto any fixed part of the magnet assembly. The only disadvantage would be the extra depth of the rear cup 38.

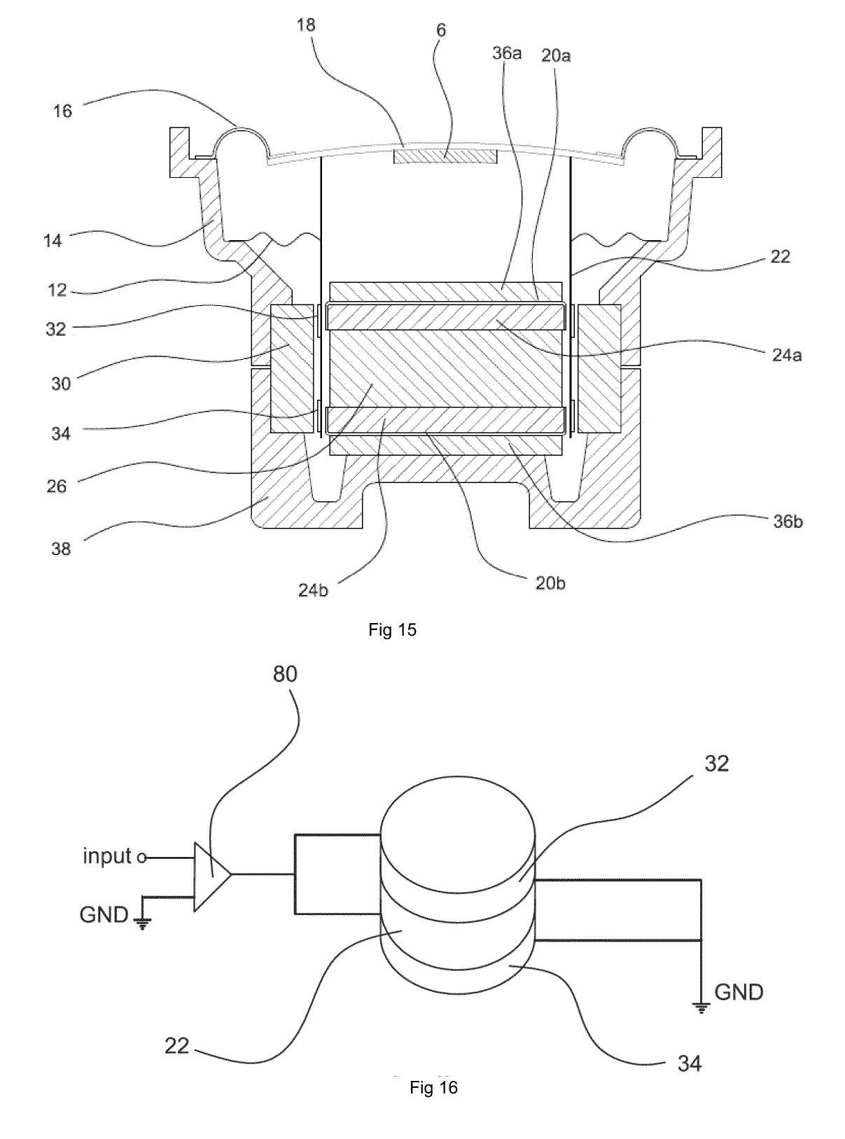

In some cases it may be convenient to use a non-flat diaphragm. FIG. 15 shows a variation of the device of FIG. 3 in which the panel 18 is in the form of a shallow dome.

FIG. 16 shows a schematic diagram of the connection of the device to a single amplifier 80. The amplifier drives the two split coils 32, 34 which are wired in parallel in this example and wound onto the former 22. The load presented to the amplifier 80 is half the value of each coil's resistance. Accordingly, for an 8 ohm load, the two coils 32, 34 would each need to be 16 ohms.

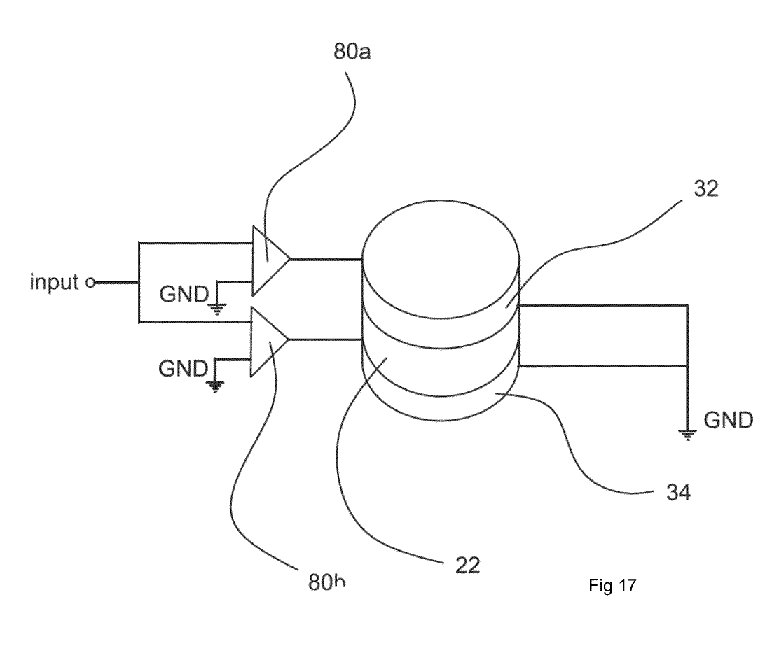

FIG. 17 shows a schematic diagram of the connection of the device to a pair of amplifiers 80a, 80b. The same input signal is fed to both amplifiers, but each one drives one section of the split coil by itself. This means that for an amplifier which needs to drive 8 ohms, the split coil sections 32, 34 both need to have a resistance of 8 ohms. This arrangement will give a significant increase in output. The two split coils in the case are both acting in harmony but driven from separate amplifiers.

No doubt many other effective alternatives will occur to the skilled person. It will be understood that the invention is not limited to the described embodiments and encompasses modifications apparent to those skilled in the art lying within the spirit and scope of the claims appended hereto.

1. An acoustic device comprising
a diaphragm having an area and having an operating frequency range comprising a part in which the diaphragm moves in whole body mode and a part which includes at least the first bending mode,
a moving coil transducer adapted to move the diaphragm in translation and having a voice coil coupled to the diaphragm and a magnet system and adapted to exchange energy with the diaphragm, and
at least one mechanical impedance means coupled to or integral with the diaphragm,
the positioning and mass of the transducer voice coil and of the at least one mechanical impedance means being such that the net modal transverse velocity over the area of the diaphragm tends to zero,
wherein the transducer comprises a moving coil assembly having a coil former on which are mounted a plurality of voice coils in an axially-spaced array.

2. An acoustic device according to claim 1, wherein said diaphragm is a circular diaphragm.

3. An acoustic device according to claim 1, wherein said diaphragm is a substantially flat diaphragm.

4. An acoustic device according to claim 1, wherein said moving coil transducer comprises a plurality of moving coil transducers.

5. An acoustic device according to claim 1, wherein the transducer has symmetrical magnetic circuits for the voice coils.

6. An acoustic device according to claim 5, wherein the voice coils are symmetrically positioned on the voice coil former.

7. An acoustic device according to claim 1, wherein the voice coils are connected in parallel.

8. An acoustic device according to claim 1, wherein a coupling device is connected between the coil former and the diaphragm.

9. An acoustic device according to claim 8, wherein the coupling device is connected to the diaphragm at or adjacent to the first nodal line of bending resonance of the diaphragm.

10. A method of making an acoustic device having a diaphragm having an area and having an operating frequency range with a part in which the diaphragm moves in whole body mode and a part which includes at least the first bending mode,
the method comprising
choosing the diaphragm parameters such that it has at least one resonant mode in the operating frequency range,
coupling a voice coil of a moving coil transducer to the diaphragm to exchange energy with the diaphragm,
arranging at least one mechanical impedance means on the diaphragm, and
selecting the positioning and mass of the voice coil and the positioning and parameters of the at least one mechanical impedance means so that the net transverse modal velocity over the area tends to zero, and
arranging the moving coil to comprise an assembly having a coil former on which are mounted a plurality of voice coils in an axially spaced array.

11. A method of making an acoustic device according to claim 10, wherein the diaphragm is circular.

12. A method of making an acoustic device according to claim 10, wherein the diaphragm is flat.

13. A method of making an acoustic device according to claim 10, wherein a plurality of moving coil transducers are coupled to the diaphragm.

14. A method of making an acoustic device according to claim 10, wherein the transducer has symmetrical magnetic circuits for the voice coils.

15. A method of making an acoustic device according to claim 14, wherein the voice coils are positioned symmetrically on the voice coil former.

16. A method of making an acoustic device according to claim 10, wherein the voice coils are connected in parallel.

17. A method of making an acoustic device according to claim 10, wherein a coupling device is connected between the coil former and the diaphragm.

18. A method of making an acoustic device according to claim 17, wherein the coupling device is connected to the diaphragm at or adjacent to the first nodal line of bending resonance of the diaphragm.

19. An acoustic device comprising
a diaphragm having an area and having an operating frequency range comprising a part in which the diaphragm moves in whole body mode and a part which includes at least the first bending mode,
a moving coil transducer adapted to move the diaphragm in translation and having a voice coil coupled to the diaphragm and a magnet system and adapted to exchange energy with the diaphragm, and
at least one mechanical impedance means coupled to or integral with the diaphragm,
the positioning and mass of the transducer voice coil and of the at least one mechanical impedance means being such that the net modal transverse velocity over the area of the diaphragm is at least reduced to tend to balance at least selected modes in the operating frequency range with the balancing of the selected modes being achieved substantially by the positioning and mechanical impedance of the transducer,
wherein the transducer comprises a moving coil assembly having a coil former on which are mounted a plurality of voice coils in an axially spaced array.

20. A method of making an acoustic device comprising a diaphragm having an area and having an operating frequency range with a part in which the diaphragm moves in whole body mode and a part which includes at least the first bending mode,
the method comprising
choosing the diaphragm parameters such that it has at least one resonant mode in the operating frequency range,
coupling the voice coil of a moving coil transducer to the diaphragm to exchange energy with the diaphragm,
arranging at least one mechanical impedance means coupled on the diaphragm, and arranging the positioning and mass of the transducer voice coil and of the at least one mechanical impedance means to be such that the net modal transverse velocity over the area of the diaphragm is at least reduced to tend to balance at least selected modes in the operating frequency range with the balancing of the selected modes being achieved substantially by the positioning and mechanical impedance of the transducer, and
arranging the moving coil to comprise an assembly having a coil former on which are mounted a plurality of voice coils in an axially spaced array.
